(19) United States
(12) Patent Application Publication
(10) Pub. No.: US 2004/0158625 A1
(43) Pub. Date: Aug. 12, 2004

(54) System and method for efficient master agent utilization

(75) Inventor: Timothy E. Neale, Hampstead, NH (US)

Correspondence Address: WIND RIVER SYSTEMS, Legal Department, Attn: Patents, 500 Wind River Way, Alameda, CA, 94501, US

(73) Assignee: Wind River Systems, Inc.

(21) Appl. No.: 10/334,621

(22) Filed: Dec. 30, 2002

(51) Int. Cl. G06F 15/16; G06F 15/173

(52) U.S. Cl. 709/223; 709/206; 719/317; 709/208

(57) ABSTRACT

A system and method is described in the context of an AgentX master-sub-agent communication system to provide a registration tree at the master agent having nodes representing one or a range of object identifiers (sub-trees) managed by sub-agents in the system. The master agent receives registration requests from the sub-agents and registers the object identifiers according to an AgentX registration process by adding nodes to the registration tree. The master agent processes SNMP requests by traversing the registration tree to determine the authoritative sub-agent having control of the specified objects. Range information is stored in the tree nodes to reduce storage requirements and increase processing efficiency.

### BACKGROUND INFORMATION

As part of a distributed computing network, it is desirable to have a management system that allows for monitoring and management of remotely located devices connected to the network. For example, in the case of a remotely located network message router, it may be desirable to be able to detect the configuration of the router (e.g., number and identification of communication ports), changes in state of the router (e.g., cold boot, warm boot), and statistics collected by the router (e.g., messages transmitted, messages dropped).

As part of the Internet Protocol (IP) suite of protocols, the Simple Network Management Protocol (SNMP) has been described as a system for managing remote devices connected via IP networks. SNMP specifies a message-passing system that permits a monitoring device (a client) to communicate with a monitored device (an agent) in order to request or set information stored in the monitored device's Management Information Base (MIB). The monitoring device sends an SNMP message to a device it wishes to communicate with using the User Datagram Protocol (UDP) over the IP network. If the client device wants to obtain information from the MIB, it can send, for example, a “GetRequest” message including a list of variables to query (specified using a list of variable bindings). The monitored device will then return a “GetResponse” message that returns the contents of the variables (or an error). If the client device wants to change information in the MIB, it can send, for example, a “SetRequest” message with a list of variables and values. The monitored device will then return a “GetResponse” message that confirms the variable values (or indicates an error). The first version of SNMP (referred to as SNMPv1) is generally described in Request For Comment (RFC) 1157, “A Simple Network Management Protocol (SNMP),” J. Case et al., May 1990, and is well known by those of skill in the art. (All RFCs referred to herein are available from the Internet Engineering Task Force www.ietf.org).

The MIB comprises a database of the elements accessible via SNMP, where each element is represented by one or more objects. The objects are arranged in a tree structure in the MIB, and each is identified according to the Structure of Management Information (SMI), as specified in RFC 1155 (and revisions thereto). Several MIB definitions have been established as standard (MIB-I, MIB-II), and addressing for these MIB objects is specified by RFCs 1156 and 1213, respectively. Other MIB objects may be defined by individual developers using specially designated areas of the SMI tree.

The original version of SNMP has been subsequently revised to support additional functionality, such as security and communities/contexts. These revisions have been described in several RFCs, for example RFCs 1901-1908 (SNMPv2, SNMPv2c) and RFCs 2271-2275 (SNMPv3).

An additional protocol that has been defined to operate in conjunction with SNMP is the Agent Extensibility Protocol (AgentX). AgentX describes a system that permits a number of “sub-agents” to operate in conjunction with a “master” SNMP agent. The sub-agents need not be SNMP aware; the master agent is tasked with performing SNMP communications over the network. The sub-agents, however, are tasked with maintaining management information (MIBs) related to their sphere of influence. The sub-agents communicate with the master agent using messages formatted according to the AgentX protocol. Sub-agents are required to register with the master agent and indicate those MIB objects which the sub-agent manages.

As an example of the operation of AgentX, when an SNMP request for information is received by the master agent, it formulates an AgentX message to request the appropriate information from the sub-agent that is registered as the manager of that information. The sub-agent then sends an AgentX response message returning the information to the master agent, which can then formulate an SNMP response message containing the requested information. Further description of the AgentX protocol may be found in RFC 2257.

The implementation of the registration functions of the master agent is important to insure that SNMP requests received by the master agent can be handled accurately and quickly. Furthermore, as master agents can be implemented in embedded devices that have limited resources (e.g., limited memory capacity), it is important to achieve desired functionality with the smallest memory usage possible while adhering to AgentX Protocol requirements.

### SUMMARY

According to an exemplary embodiment according to the present invention, a master-sub-agent communication system is described, comprising a registration tree and a master agent. The registration tree includes a first node providing a representation of a range of object identifiers, and a first leaf corresponding to the first node and providing a representation of a first sub-agent having control of objects identified by the range of object identifiers. The master agent is configured to (a) receive an SNMP message containing a specified object identifier, (b) select the first sub-agent as an authoritative sub-agent when the specified object identifier is within the range of object identifiers, (c) create an AgentX message containing the specified object identifier, and (d) send the AgentX message to the authoritative sub-agent.

A method of processing registrations is also described, comprising receiving a registration request from a sub-agent, the registration request including a range of object identifiers, adding a new node to a registration tree representing the range of object identifiers, and adding a new leaf corresponding to the new node to the registration tree, the new leaf containing a representation of the sub-agent.

### BRIEF DESCRIPTION OF THE DRAWINGS

FIG. 1 shows a block diagram of a system according to the present invention.

FIG. 2 shows a block diagram of an exemplary master agent according to the present invention.

FIG. 3 shows an exemplary registration tree according to the present invention.

FIG. 4 shows a flow chart of an exemplary registration process according to the present invention.

FIG. 5 shows a block diagram of an example system according to the present invention.

FIG. 6 shows a first registration tree of the example of FIG. 5 according to the present invention.

FIG. 7 shows a second registration tree of the example of FIG. 5 according to the present invention.

FIG. 8 shows a third registration tree of the example of FIG. 5 according to the present invention.

FIG. 9 shows a fourth registration tree of the example of FIG. 5 according to the present invention.

FIG. 10 shows a flow chart of an exemplary SNMP message handling process according to the present invention.

### DETAILED DESCRIPTION OF THE PREFERRED EMBODIMENTS

In an embodiment according to the present invention, an exemplary AgentX system is implemented that allows for improved usage of system memory resources while offering compliance with applicable SNMP and AgentX specifications. The exemplary AgentX system includes a master agent and any number of sub-agents implementing the AgentX protocol for communications between each other. The master agent maintains a registration hierarchical data structure—for example, a tree—for registration of MIB objects (or sub-trees of MIB objects) supported by the sub-agents. Where ranges of MIB objects are specified by a sub-agent, the master agent creates a single node corresponding to the range of MIB objects in lieu of individual nodes for each object/sub-tree represented in the range.

By using a registration tree, dynamic alterations of registrations can be achieved without potential loss of information (for example, by system reset), as well as convenient representations of address ranges. For example, by using a single node in the registration tree to represent a range of MIB addresses, the size of the registration tree can be significantly reduced, thus reducing the memory usage of the master agent. The registration tree can be implemented without any modification of the interfaces between the master agent and sub-agents, in full compliance with the AgentX specification, and in conjunction with other standardized AgentX structures (e.g., the AgentX MIB).

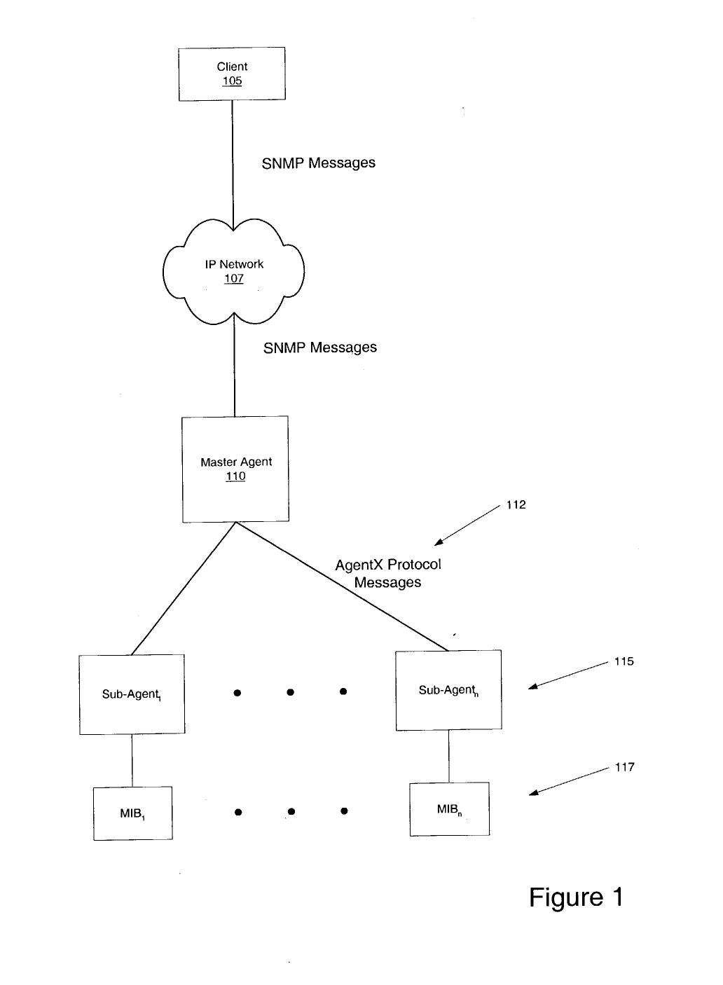

FIG. 1 shows a block diagram of a system implemented according to the present invention. Master agent 110 is communicatively coupled to an SNMP client 105 via an IP network 107. IP network 107 allows SNMP messages to be transmitted between client 105 and master agent 110, for example, to retrieve or set information from MIB objects. Master agent 110 is further communicatively coupled to one or more sub-agents 115 via communication channels 112. Communication channels 112 may take various forms—IP networks, remote procedure calls (RPCs), inter-process communication (IPC) facilities such as message passing, etc.—as long as the channels 112 are capable of transmitting AgentX messages. Sub-agents 115 may be implemented on the same hardware platform as master agent 110, or may be implemented on separate hardware platforms.

Each sub-agent 115 is responsible for managing a MIB 117. MIBs 117 may each contain one or more objects addressable according to the SMI. As part of the AgentX protocol, sub-agents 115 will register their MIBs 117 with the master agent 110, in order to allow the master agent to access these MIBs when SNMP messages are received. MIBs 117 may include objects that overlap—objects that have the same SMI address. Master agent 110 may employ a process for determining which object to use in resolving SNMP requests, as will be discussed below.

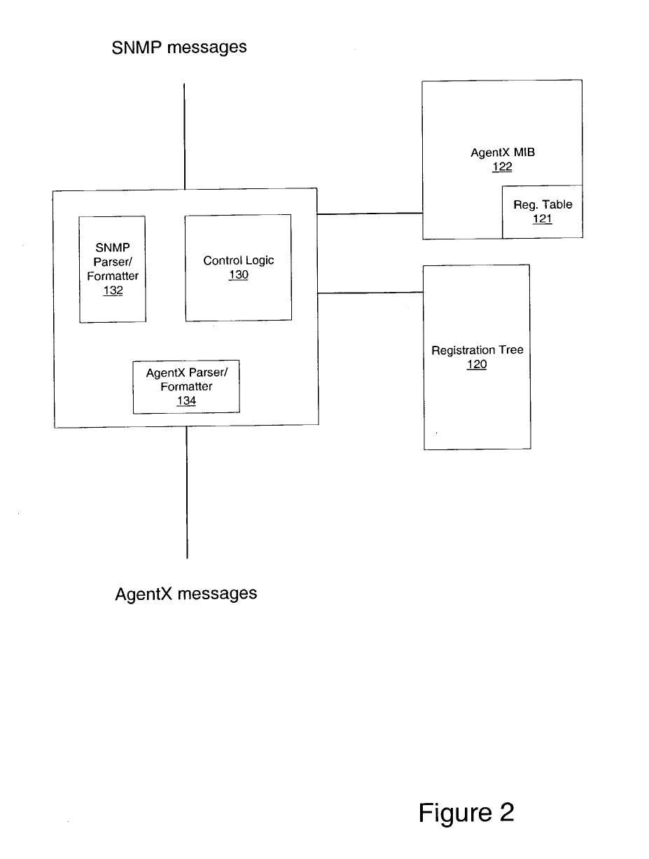

FIG. 2 shows a block diagram illustrating an exemplary master agent 110 and related structures. Master agent 110 includes a control logic portion 130, an SNMP parser/formatter portion 132 and an AgentX parser/formatter portion 134. SNMP messages received by the master agent 110 are parsed by the SNMP parser/formatter portion 132 to identify and format message elements for use by the control logic 130. Control logic 130 implements functionality to determine the appropriate operations to be performed in response to an SNMP message or AgentX message—for example, from which sub-agent to obtain information in response to an SNMP GetRequest message. AgentX parser/formatter portion 134 formats AgentX messages for transmission to sub-agents and parses AgentX messages received from sub-agents.

Master agent 110 tracks the MIB objects managed by sub-agents 115 through one or more registration data structures—in the preferred embodiment, a registration tree 120 and a MIB tree 122. The MIB tree 122 is a means of storing MIB information for easy access. Registration table 121 is implemented in MIB tree 122, and is used to store AgentX session information. One of the benefits of maintaining a registration tree 120 separate from MIB tree 122 is that the MIB tree 122 is not optimal for storing and manipulating registration information—for example, range information is stored in MIB tree 122 in a format that is not easily usable by control logic 130 and MIB structure is generally created at start up (whereas the registration tree is dynamically populated). Thus, the embodiment according to the present invention maintains compatibility with the MIB tree 122 while implementing the registration tree 120.

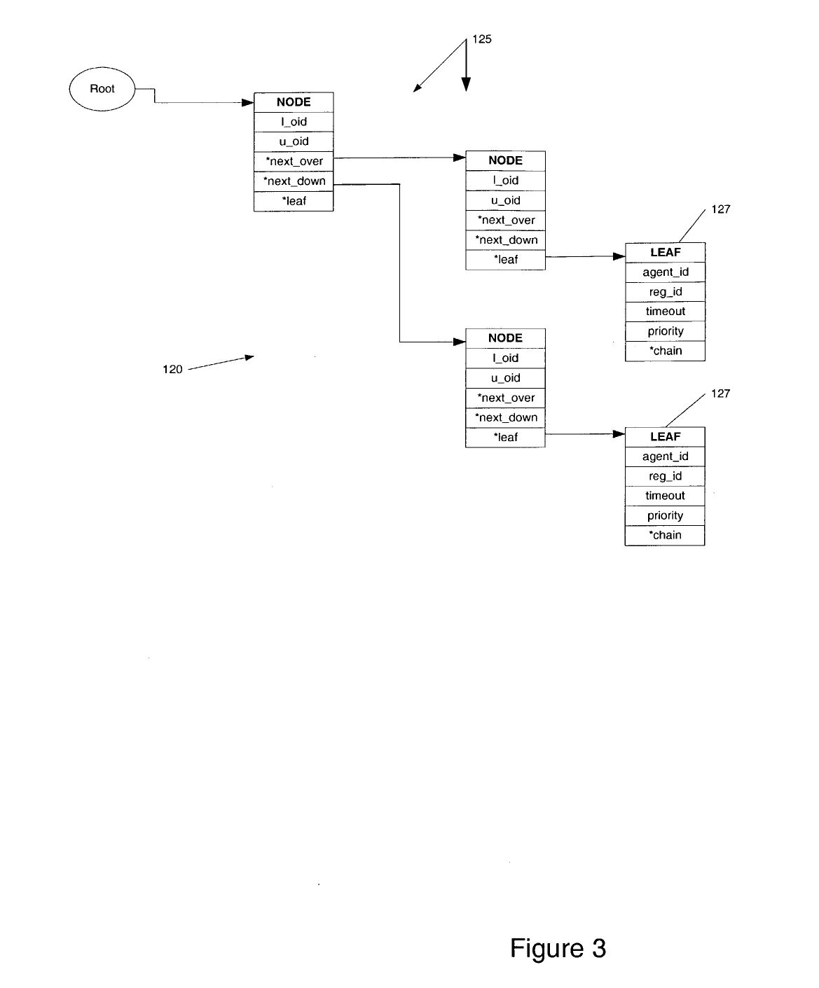

FIG. 3 illustrates the structure of an exemplary registration tree 120. In the preferred embodiment, registration tree 120 is structured as a n-tree using ordered linked lists. Registration requests, which represent “sub-trees” which the registering sub-agent 115 wishes to be considered authoritative by the master agent 110, will be maintained in the registration tree 120 for use by master agent 110 when processing SNMP messages. The registration information, besides the OIDs for the sub-tree being registered, includes the identity of the registering sub-agent and a priority code. The tree structure includes nodes which are capable of representing OID ranges.

As illustrated in FIG. 3, registration tree 120 includes nodes 125. An exemplary data structure implementing a node 125 is as follows:

data structure Registration Tree Node

| | |
|---|---|
| { | |
| integer | lower; |
| integer | upper; |
| pointer | *next_over; |
| pointer | *next_down; |
| } | |

The structure members “lower” and “upper” represent OID component values. If the node represents a range, the value of “upper” is non-zero and expected to be greater than the value of “lower,” and the node represents the range in values between (and including) them. Otherwise the node represents the single value “lower.” Members “next_over” and “next_down” are pointers used to implement the tree structure. “Next_over” points to the next node at this level in the tree and “next_down” points to the beginning of a list of sub-IDs under this one. If there are no more nodes at this level, each of “next_over” and “next_down” will contain a null value.

In the preferred embodiment, lists are created using these nodes by using the “next_over” pointer. The single value nodes are kept in numerically increasing order, to speed the performance of node lookup by master agent 110. To maintain integrity, this ordering should be maintained when nodes are added. Range nodes, if there are any, are collected together, either as a separate list or at one end of the list of single valued nodes. Range nodes need not be any particular order, as typically all range nodes will need to be examined during node lookup.

Also as illustrated in FIG. 3, registration tree 120 includes leaves 127 that may be linked to nodes 125 to provide information concerning the registration of OIDs represented by the nodes. An exemplary leaf data structure is as follows:

data structure Registration Tree Leaf

| | |
|---|---|
| { | |
| integer | agent_id; |
| integer | reg_id; |
| integer | timeout; |
| integer | priority; |
| pointer | *chain; |
| } | |

The structure member “agent_id” stores a number to identify which sub-agent 115 is responsible for the registered OID(s) represented by the node 125 attached to the leaf 127. In this preferred embodiment, this number corresponds to the AgentX “session_id” assigned to the sub-agent 115, and thus can be used by the master agent 110 to look up additional information concerning the associated sub-agent 115, such as transport and address information. The member “reg_id” identifies the registration request with which these OID(s) are associated, and may correspond to the registration index in the registration table 121 of MIB 122. The member “timeout” is the length of time, in seconds, that a master agent should allow to lapse after dispatching a message on a session before it regards the sub-agent as not responding. If the value of timeout is 0 then default timeout for the session is used, which was established when the session was opened. The member “priority” records the priority information provided by the sub-agent 115 for its registration of the OID(s) represented. In this embodiment, priority is represented by a number from 1 to 255 with lower numbers taking precedence over higher ones. The member “chain” is used when one or more alternate leaves must be stored, for example when duplicate OIDs are registered with different priorities (described below).

Using the node and leaf data structures described above, registration tree 120 can be dynamically constructed from registration requests received by master agent 110 from sub-agents 115, and subsequently used by master agent 110 to identify the sub-agent 115 associated with OIDs referenced in SNMP messages.

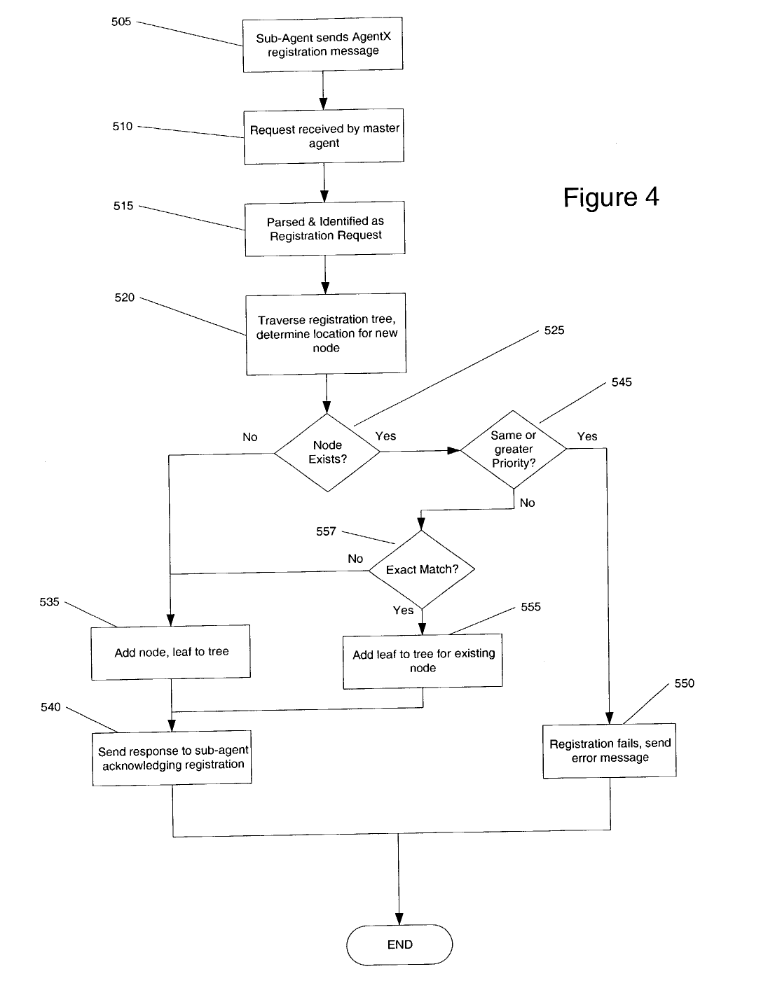

FIG. 4 shows a flow chart illustrating an exemplary registration process, according to the preferred embodiment of the present invention. In step 505, a sub-agent 115 sends an AgentX registration message to master agent 110. Prior to sending this registration message, sub-agent 115 will have sent a message to master agent 110 to open an AgentX “session” with master agent 110, and master agent 110 will have agreed to establish a session with sub-agent 115 and recorded session and contact information in order to communicate with sub-agent 115. Master agent 110 receives the message (step 510), parses the message and identifies it as a registration message from sub-agent 115 (step 515). Master agent 110 also identifies in the message the OIDs for which sub-agent 115 has requested registration and the associated priority code. The master agent 110 then traverses the registration tree 120 (step 520) to determine the proper location to store the registration information. Starting with the root pointer, master agent 110 traverses the nodes of the registration tree 120 to determine the location at which a node 125 representing the current registration request may be inserted. Since the registration tree is hierarchical, and at each level of the hierarchy the list of OIDs is ordered (preferably by increasing ID number), tree traversal may be performed using simple algorithms. In the preferred embodiment, range nodes are inserted before single nodes at the same level of the registration tree 120 (which allows range nodes to be analyzed first during the traversal).

Once the proper location for node insertion is determined, the master agent 110 checks to see if a node 125 already exists in the tree at this location that includes all or part of the OIDs to be registered at the same priority (step 525). For a single value node, this checking means making sure no single value node of the same priority is in the tree, and that the ranges on the tree at that level do not include that value. If the new registration is a range, then all values in the range must pass the same check. Overlapping registrations may be handled, for example, as described in RFC 2741. If the new registration does not overlap, master agent 110 inserts a new node 125 into registration tree 120 representing the OIDs to be registered and a new leaf 127 representing the sub-agent 115 that manages these objects (step 535). If the OIDs represent a range, the range information is including in the inserted node data structure (i.e., the “lower” and “upper” members are set to the specified OID range). Master agent 110 also sends an acknowledgement message to sub-agent 115 indicating that registration was successful (step 540).

If a previous node exists that covers part or all of the OIDs of the registration request, master agent 110 determines whether the priority of the current registration request is equal to or less than the priority of the previously registered OIDs (step 545). If so, an error message is sent to sub-agent 115 indicating that the OIDs have already been registered (step 550), and no registration takes place. If a higher priority has been specified, the OIDs may be registered. It is checked whether the OIDs of the current registration request and the previously registered OIDs match exactly (step 557). If not, an entry is added in the registration tree 120 (step 535) representing the registration (for example, a range node if the new registration is for a range of OIDs), and a corresponding leaf is also added. As a result, master agent 110 may, when determining a sub-agent from which to obtain information for an SNMP request, select between the two possible sub-agents for the registered OIDs based on the priority levels assigned. Master agent 110 sends an acknowledgement message to sub-agent 115 indicating that registration was successful (step 540). If the OIDs match exactly, a new leaf 127 is added to the registration tree 120 (step 555) representing the sub-agent 115 requesting the registration, the new leaf being associated with the existing node 125 that represents the matching OIDs. This new leaf 127 will be linked to the existing leaf 127 associated with the existing node 125, for example, through the “chain” pointer member of the leaf data structure. Master agent 110 also sends an acknowledgement message to sub-agent 115 indicating that registration was successful (step 540).

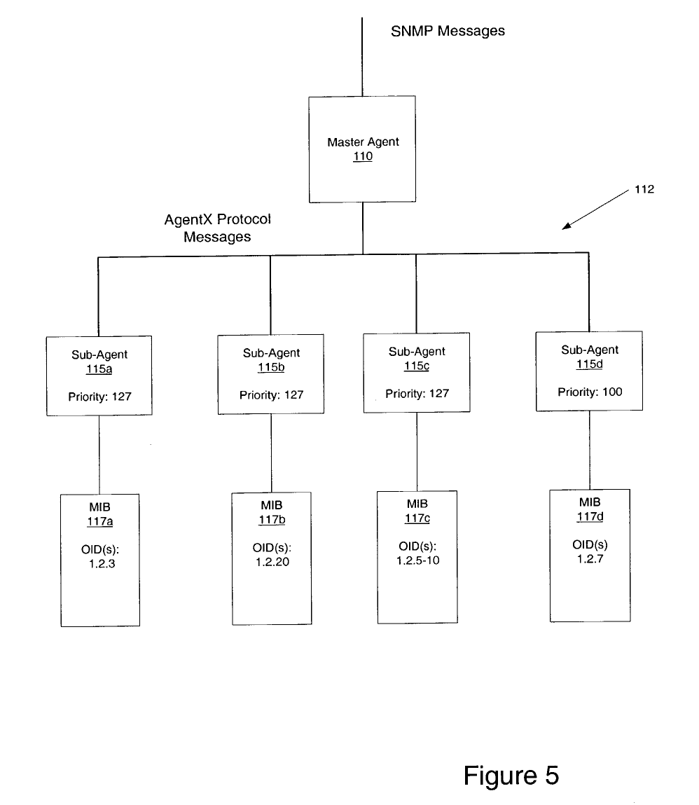

In order to further illustrate the operation of the embodiment according to the present invention, an example of the interaction between the master agent 110 and four example sub-agents 115 (denoted 115a, 115b, 115c and 115d) will be described. FIG. 5 illustrates the system, which shows master agent 110 and sub-agents 115a-d. Each sub-agent 115 manages a respective MIB 117 (denoted 117a, 117b, 117c and 117d) having OIDs for the following sub-trees: MIB 117a=1.2.3, MIB 117b=1.2.20, MIB 117c=1.2.5-10 (a range), and MIB 117d=1.2.7. Sub-agents 115a, 115b and 115c will register with priority of 127, while sub-agent 115d will register with a priority of 100 (i.e., higher priority than sub-agents 115a-c).

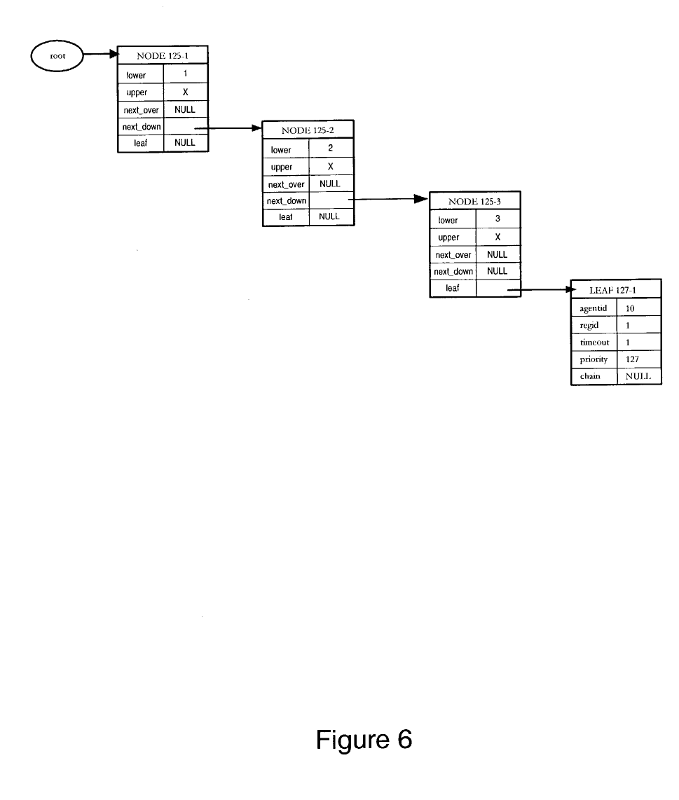

In this example, a first registration request is received by the master agent 110 from sub-agent 115a. This registration request includes the OID 1.2.3 and the priority 127, as well as session ID 10 (which identifies sub-agent 115a as the source of the request, according to a previously established session). As this is the first registration (i.e., the registration tree 120 is empty), master agent 110 determines that it is possible to register the specified OID, and inserts nodes 125-1, 125-2 and 125-3 that represent the sub-tree represented by OID 1.2.3. Master agent 110 further includes a leaf 127-1 indicating that sub-agent 115a is the source for the objects specified under OID 1.2.3. FIG. 6 illustrates diagrammatically the contents of registration tree 120 after registration of the MIB 117a for sub-agent 115a.

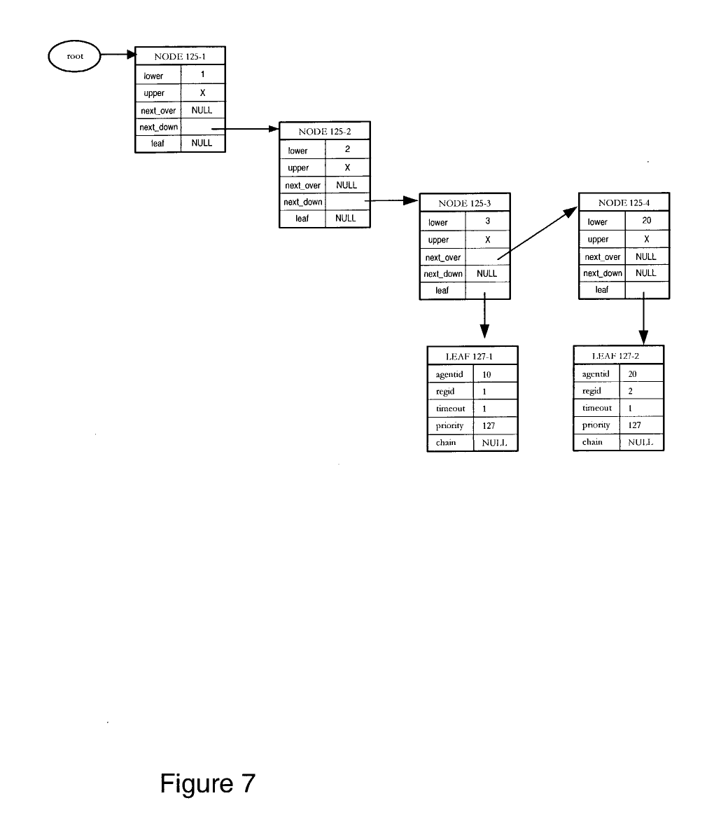

Continuing the example, a second registration request is received by master agent 110, this time from sub-agent 115b. This registration request includes OID 1.2.20, the priority 127 and the session ID 20 (which identifies sub-agent 115b as the source of the request, based on a previously opened session). Master agent 110 traverses the registration tree 120, and determines that a new node needs to be added at the same tree level as node 125-3 (but after it in the list of nodes for that level, since 3<20), and no nodes presently cover OID 1.2.20. Master agent 110 adds node 125-4 to registration tree 120 by modifying the “next_over” member of node 125-3 to point to node 125-4 and completing the entries in the node 125-4 data structure. Master agent 110 also adds a leaf 127-2 (pointed to by node 125-4) indicating that the objects specified by OID 1.2.20 are managed by sub-agent 115b. FIG. 7 illustrates diagrammatically the contents of registration tree 120 after registration of the MIB 117b of sub-agent 115b.

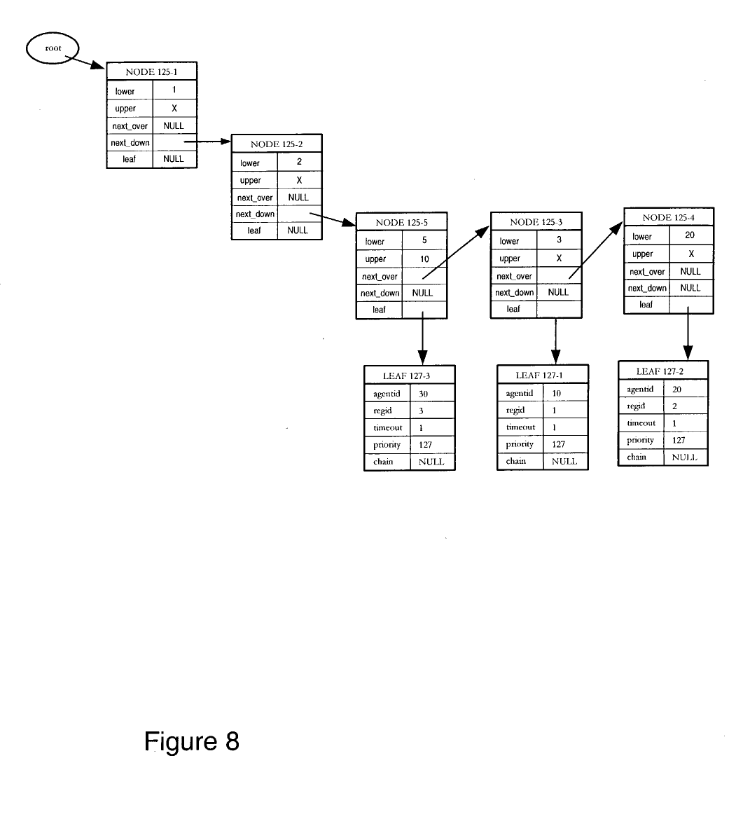

Further continuing the example, a third registration request is received by master agent 110, this time from sub-agent 115c. This registration request includes a range of OIDs—1.2.5-10—the priority 127 and the session ID 30 (which identifies sub-agent 115c as the source of the request, based on a previously opened session). Master agent 110 traverses the registration tree 120, and determines that a new node needs to be added at the same tree level as nodes 125-3 and 125-4, and no nodes presently cover any of the OIDs in the range 1.2.5-10. Master agent 110 further determines that the node to be added is a range node and thus should go at the beginning of the list of nodes. Master agent 110 adds node 125-5 representing the range 1.2.5-10 to registration tree 120 by modifying the “next_down” member of node 125-2 and completing the entries in the node 125-5 data structure. In particular, the “next_over” member of node 125-5 is set to point to node 125-3 (thus maintaining the list) and the range information is set (lower=5, upper=10). Master agent 110 also adds a leaf 127-3 (pointed to by node 125-5) indicating that the objects specified by OIDs 1.2.5-10 are managed by sub-agent 115c. FIG. 8 illustrates diagrammatically the contents of registration tree 120 after registration of the MIB 117c of sub-agent 115c.

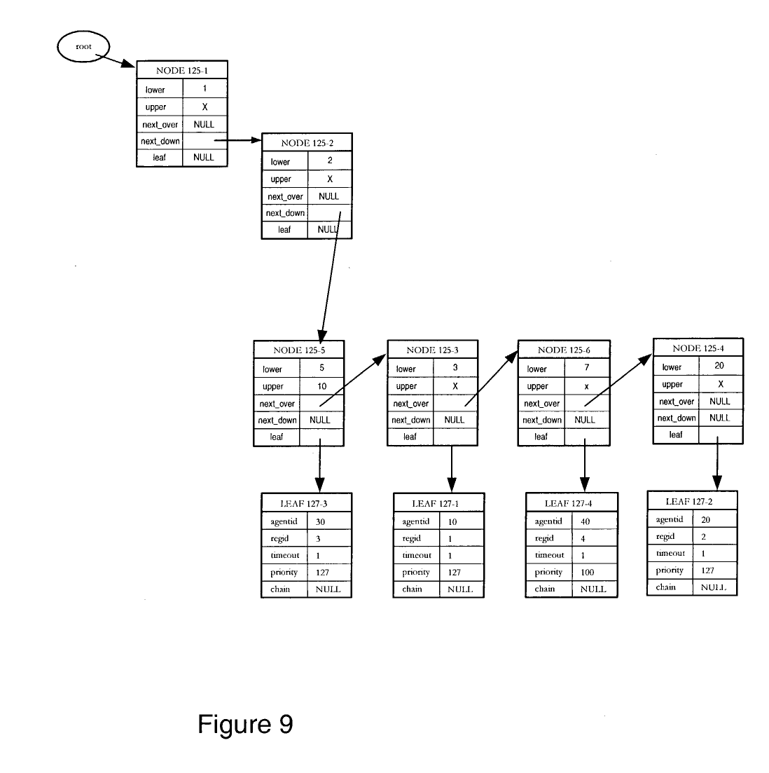

Further continuing the example, a fourth registration request is received by master agent 110, this time from sub-agent 115d. This registration request includes the OID sub-tree 1.2.7, the priority 100 and the session ID 40 (which identifies sub-agent 115d as the source of the request, based on an earlier established session). Master agent 110 traverses the registration tree 120, and determines that a new node should be added at the same tree level as nodes 125-3, 125-4 and 125-5, but node 125-5 already covers the sub-tree 1.2.7 (because 1.2.7 falls within the range 1.2.5-10). Master agent 110 compares the priority of the existing registration covering sub-tree 1.2.7 (priority 127, indicated by leaf 127-3) to the priority of the current registration request (priority 100), and determines that the current registration request has a higher priority. Master agent 110 adds node 125-6 representing the sub-tree 1.2.7 to registration tree 120, completing the entries in the node 125-6 data structure. Master agent 110 also adds a leaf 127-4 (pointed to by node 125-6) indicating that the objects specified by OID 1.2.7 are managed by sub-agent 115d with a priority of 100. FIG. 9 illustrates diagrammatically the contents of registration tree 120 after registration of the MIB 117d of sub-agent 115d.

Although multiple registrations exist for sub-tree 1.2.7, the master agent will be able to determine which sub-agent to communicate with (the “authoritative” sub-agent) when an SNMP message is received referencing this sub-tree by checking the priority value assigned to these registrations (and stored in the associated leaf data structure).

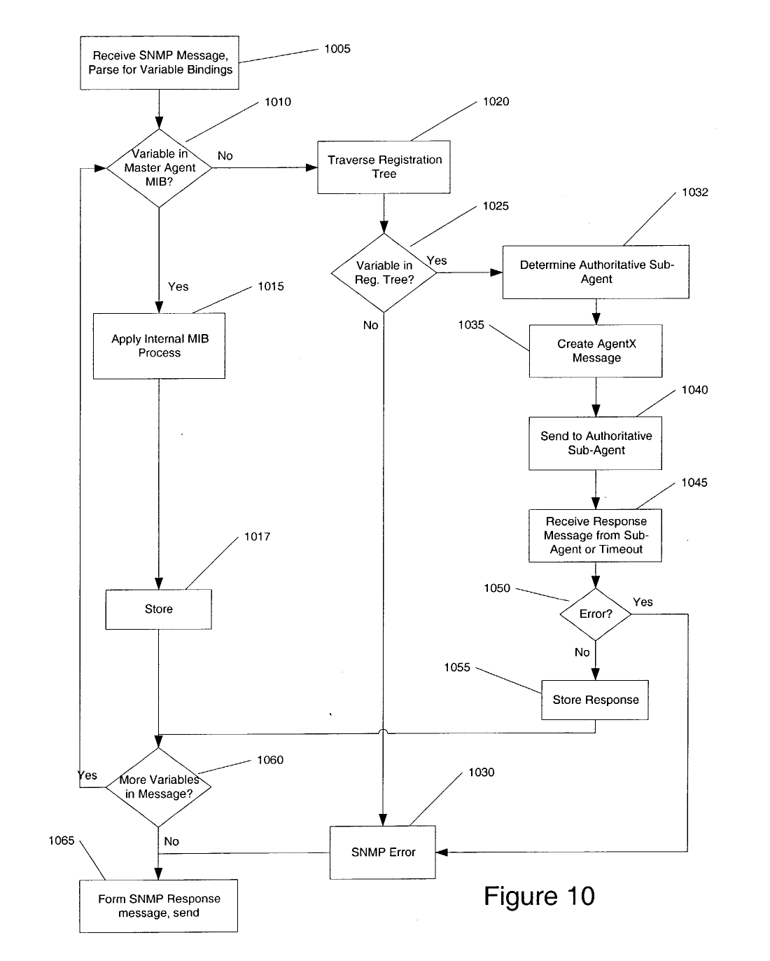

FIG. 10 shows a flow chart describing an exemplary process by which master agent 110 processes incoming SNMP messages. Master agent 110 first receives an SNMP message (step 1005) and parses the message to determine its type (e.g., GetRequest, SetRequest, GetNextRequest, etc.). Master agent 110 also determines if any variable bindings have been included in the message. If so, master agent 110 processes each variable, first determining whether the variable listed in the message are part of a MIB maintained by the master agent 110 (step 1010). If so, the master agent 110 processes the variable according to its internal variable handling processes (step 1015) and stores the result for inclusion in the SNMP response message (step 1017). If the variable listed is not part of the MIB managed by master agent 110, the master agent initiates an AgentX messaging process to determine whether any of the sub-agents 115 having an open session has registered a MIB that includes the variable.

Master agent 110 begins traversing the registration tree 120 (step 1020) to locate the variable. Locating the variable may be accomplished by traversing the nodes of the registration tree to locate a node that represents the object ID of the variable (e.g., a range that includes the object ID of the variable). In the preferred embodiment, traversing may include checking each range node at the indicated level of the tree and then those single nodes at the indicated level of the tree until either a node representing the OID is found or it is determined that no nodes representing the specified OID are present in the tree. If the variable is not represented in the registration tree (step 1025), an error condition exists, and an SNMP error message is prepared (step 1030). Otherwise, if the variable is found in the registration tree, the master agent 110 determines an authoritative sub-agent 115 to which an AgentX message should be sent (step 1032). This may involve choosing between overlapping ranges on the basis of priority. The master agent looks to the leaf corresponding to the node to determine the sub-agent that has registered the object ID (for example, by examining the “leaf” member of the node data structure for the pointer to the leaf corresponding to the node). Where a single leaf corresponds to a single node, the sub-agent represented by the leaf is selected as the authoritative sub-agent for the object ID. Where multiple leaves correspond to a single node, or where multiple nodes represent the object ID (each having one or more corresponding leaves), the master agent selects the sub-agent having the highest priority (as reflected in each leaf by the “priority” member of the leaf data structure).

Once an authoritative sub-agent is selected, an AgentX message is created and sent to the authoritative sub-agent (step 1040) corresponding to the request made by the SNMP message. For example, for an SNMP message that is a GetRequest PDU, the master agent will create an AgentX GetPDU message that includes the object ID. The transmission of the AgentX message may be accomplished according to the transmission information stored, for example, as part of the session information for the authoritative sub-agent stored in the registration table 121. The master agent 110 then waits for a response AgentX message from the authoritative sub-agent, or the expiration of a timeout period (step 1045). If there is no response message within the timeout period, or if the response message indicates an error (step 1050), an error condition exists, and an SNMP response message is created that reflects an error condition during processing of the SNMP message (step 1030). Otherwise, the AgentX response message is parsed and the data included therein is stored (step 1055) for inclusion in the SNMP response message to be generated by the master agent 110. Note that master agent 110 need not be idle while awaiting a response from the authoritative sub-agent, but can be processing other variables (for example, through the use of multiple executing tasks).

After a variable binding has been processed as described above (or concurrently with variable processing, in the case of multiple executing tasks), the master agent 110 checks to see if further variables require processing (step 1060). If so, the process steps described above are repeated for each variable in the SNMP message. Once all variables have been processed (or once an error has occurred), the master agent 110 generates the SNMP response message corresponding to the received SNMP message, and transmits the SNMP response message to the client which sent the received SNMP message (step 1065).

Additional complexity is introduced when processing SNMP GetNextRequest PDUs, as the master agent 110 must determine the “next” OID (lexicographically after a specified OID) for which an instance is actually maintained by registered sub-agents 115. Since a sub-agent 115 may register a sub-tree which has no actual instances, the only way to determine the actual next OID instance is to send an AgentX GetNext PDU to the sub-agent and examine the response. It may be necessary to send requests to multiple sub-agents in order to determine the actual next OID instance. The structure of the registration tree 120 lends itself to the sequential search necessary to this process. A GetNext AgentX PDU is sent to the first sub-agent that has registered an OID or sub-tree greater than the specified OID. The AgentX GetNext PDU contains an end value that signifies the area of the sub-agent's MIB on which the GetNext should be performed. This end value should be the OID that would be accessed if the GetNext were performed on the master agent's MIB tree. If no instance is reported by the AgentX sub-agent, the process moves on to the next registered sub-tree, which may be found in a single value node or a range node. This continues until either an actual next instance is found at a sub-agent or the master agent determines that its MIB tree OID is closest to the specified OID.

Another special case involves processing of SNMP GetBulkRequest PDUs. In general, the master agent 110 can translate an SNMP GetBulkRequest into one or more GetBulk AgentX requests on a per-variable basis after following the procedure for registration lookup described above for GetRequest PDUs.

The embodiment described above can be used in conjunction with the community/context aspects of the SNMP protocol, with minimal modification. For example, a separate registration tree 120 may be maintained for each context being supported by master agent 110, with each registration tree accessible via a linked list of existing contexts (having a pointer to the root of each registration tree).

The embodiment according to the present invention can take the form of computer software implemented in the memory system of a computing device having a processor to execute the software, as machine readable software stored on a non-volatile media (e.g., optical or magnetic disk) for later execution by a computing system, as software translatable into machine readable software (e.g., through compilation), or as hardware/firmware implemented within a semiconductor device or devices (e.g., gate array, ASIC).

In the preceding specification, the invention has been described with reference to specific exemplary embodiments thereof. It will, however, be evident that various modifications and changes may be made thereunto without departing from the broader spirit and scope of the invention as set forth in the claims that follow. The specification and drawings are accordingly to be regarded in an illustrative rather than restrictive sense.

What is claimed is:

1. A master-sub-agent communication system comprising:
a registration tree, the registration tree including
a first node providing a representation of a range of object identifiers, and
a first leaf corresponding to the first node and providing a representation of a first sub-agent having control of objects identified by the range of object identifiers; and
a master agent configured to
(a) receive an SNMP message containing a specified object identifier,
(b) select the first sub-agent as an authoritative sub-agent when the specified object identifier is within the range of object identifiers,
(c) create an AgentX message containing the specified object identifier, and
(d) send the AgentX message to the authoritative sub-agent.

2. The system of claim 1, further comprising:
an MIB, the MIB including an AgentX registration table.

3. The system of claim 1, wherein the range of object identifiers includes at least one sub-tree of objects.

4. The system of claim 1, wherein the first node is an instance of a node data structure, the node data structure including
a first member to store a lower object identifier of the range of object identifiers;
a second member to store a higher object identifier of the range of object identifiers;
a third member to store a pointer to a first further node at a same tree level; and
a fourth member to store a pointer to a second further node at a lower tree level.

5. The system of claim 1, wherein the first leaf is a first instance of a leaf data structure, the leaf data structure including
a first member to store the representation of the first sub-agent; and
a second member to store a priority of the first sub-agent.

6. The system of claim 1, wherein the master agent is further configured to select the first sub-agent as an authoritative sub-agent when the specified object identifier is within the range of object identifiers by
locating the first node in the registration tree,
identifying the specified object identifier as being within the range of object identifiers, and
retrieving the representation of the first sub-agent from the first leaf.

7. The system of claim 1, wherein the registration tree further includes a second leaf corresponding to the first node and providing a representation of a second sub-agent having control of objects identified by the range of object identifiers, the second sub-agent having a different priority than the first sub-agent; and
wherein the master agent is further configured to
detect the presence of the second leaf, and
select the second sub-agent as the authoritative sub-agent when the priority of the second sub-agent is higher than the priority of the first sub-agent.

8. The system of claim 7, wherein the first leaf is an instance of a leaf data structure, the leaf data structure including
a first member to store the representation of the first sub-agent,
a second member to store a priority of the first sub-agent, and
a third member to store a pointer to a further leaf corresponding to the node; and
wherein the third member of the first leaf stores a pointer to the second leaf.

9. The system of claim 1, wherein the registration tree further includes
a second node representing at least one alternate object identifier within the range of object identifiers, and
a third leaf corresponding to the second node and providing a representation of a third sub-agent having control of objects represented by the at least one alternate object identifier and having a priority different than the first sub-agent, and
wherein the master agent is further configured to
detect the presence of the second node, and
select the third sub-agent as the authoritative sub-agent when the specified object identifier is within the at least one alternate object identifier and the priority of the third sub-agent is higher than the priority of the first sub-agent.

10. The system of claim 9, wherein the first node is an instance of a node data structure, the node data structure including
a first member to store a lower object identifier of the range of object identifiers,
a second member to store a higher object identifier of the range of object identifiers,
a third member to store a pointer to a first further node at a same tree level, and
a fourth member to store a pointer to a second further node at a lower tree level,
wherein the third member of the first node contains a pointer to the second node.

11. The system of claim 5, wherein the leaf data structure further includes
a third member to store a registration id associated with the first sub-agent;
a fourth member to store a timeout value for communications with the first sub-agent; and
a fifth member to store a pointer to a further leaf corresponding to the node.

12. A method, comprising:
receiving an SNMP message containing a specified object identifier;
locating a first node representing the specified object identifier in a registration tree, including
determining whether the first node represents a range of object identifiers, and
when the first node represents a range of object identifiers, determining whether the specified object identifier is within the range of object identifiers;
locating a first leaf corresponding to the first node and representing a first sub-agent having control of objects identified by the specified object identifier;
selecting the first sub-agent as an authoritative sub-agent;
creating an AgentX message containing the specified object identifier; and
sending the AgentX message to the authoritative sub-agent.

13. The method of claim 12, wherein the selecting includes
detecting the presence of a second leaf corresponding to the first node and representing a second sub-agent having control of objects identified by the specified object identifier, the second sub-agent having a priority different than the first sub-agent;
comparing the priority of the first sub-agent and second sub-agent,
selecting the second sub-agent as the authoritative sub-agent when the priority of the second sub-agent is higher than the priority of the first sub-agent, and
selecting the first sub-agent as the authoritative sub-agent when the priority of the first sub-agent is higher than the priority of the second sub-agent.

14. The method of claim 13, wherein the comparing includes comparing a priority member of the first leaf to a priority member of the second leaf.

15. The method or claim 13, wherein the detecting includes determining whether a pointer member of the first leaf includes a pointer to the second leaf.

16. The method of claim 12, wherein the selecting includes
detecting the presence of a second node representing the specified object identifier in the registration tree;
locating a third leaf corresponding to the second node and representing a third sub-agent having control of objects identified by the specified object identifier, the third sub-agent having a priority different than the first sub-agent;
comparing the priority of the first node to the priority of the third node;
selecting the third sub-agent as the authoritative sub-agent when the priority of the third sub-agent is higher than the priority of the first sub-agent; and
selecting the first sub-agent as the authoritative sub-agent when the priority of the first sub-agent is higher than the priority of the third sub-agent.

17. The method of claim 16, wherein the detecting includes
determining whether a pointer member of the first node includes a pointer to the second node.

18. The method of claim 16, wherein the comparing includes
comparing contents of a priority member of the first leaf to contents of a priority member of the third leaf.

19. A method of processing registrations, comprising:
receiving a registration request from a sub-agent, the registration request including a range of object identifiers;
adding a new node to a registration tree representing the range of object identifiers; and
adding a new leaf corresponding to the new node to the registration tree, the new leaf containing a representation of the sub-agent.

20. The method of claim 19, further comprising:
traversing the registration tree to determine a location in the registration tree to add the new node.

21. The method of claim 19, wherein adding the new node includes setting a pointer member of a pre-existing node of the registration tree to point to the new node.

22. The method of claim 21, further comprising:
determining whether the pre-existing node of the registration tree represents at least a portion of the range of object identifiers, the pre-existing node having a corresponding pre-existing leaf representing a second sub-agent;
not adding the new node and the new leaf when the pre-existing node of the registration tree represents at least a portion of the range of object identifiers and a priority of the first sub-agent is equal to or less than a priority of the second sub-agent.

23. The method of claim 19, further comprising:
adding an entry to an AgentX MIB registration table corresponding to the registration request.

24. A master-sub-agent communication system comprising:
a registration tree; and
a master agent configured to
receive a registration request from a sub-agent, the registration request including a range of object identifiers;
add a new node to the registration tree representing the range of object identifiers; and
add a new leaf corresponding to the new node to the registration tree, the new leaf containing a representation of the sub-agent.

25. A master-sub-agent communication system comprising:
a registration tree; and
a master agent configured to
receive a registration request from a sub-agent, the registration request including a range of object identifiers;
add a new node to the registration tree representing the range of object identifiers;
add a new leaf corresponding to the new node to the registration tree, the new leaf containing a representation of the sub-agent;
receive an SNMP message containing a specified object identifier;
determine whether the specified object identifier is within the range of object identifiers by traversing the registration tree;
when the new node represents the specified object identifier—
create an AgentX message containing the specified object identifier; and
send the AgentX message to the sub-agent.
